(19) United States
(12) Patent Application Publication
(10) Pub. No.: US 2013/0137478 A1
(43) Pub. Date: May 30, 2013

(54) Power Control

(71) Applicants: Agnieszka Szufarska, Gdansk (PL); Jaroslaw Lachowski, Nowy Sacz (PL); Klaus Ingemann Pedersen, Aalborg (DK)

(72) Inventors: Agnieszka Szufarska, Gdansk (PL); Jaroslaw Lachowski, Nowy Sacz (PL); Klaus Ingemann Pedersen, Aalborg (DK)

(73) Assignee: Nokia Siemens Networks Oy, Espoo (FI)

(21) Appl. No.: 13/704,307

(22) PCT Filed: Jun. 16, 2010
(86) PCT No.: PCT/EP2010/058448

§ 371 Date: Feb. 11, 2013

(51) Int. Cl. H04W 52/24

(52) U.S. Cl. CPC H04W 52/244
USPC 455/522

(57) ABSTRACT

The invention relates to apparatuses, a method, system, computer program, computer program product and computer-readable medium.

### FIELD

The invention relates to apparatuses, a method, system, computer program, computer program product and computer-readable medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Self-organizing networks (SON) are designed to support automated configuration and optimization of communications networks. Self-configuration enables so called “plug-and-play” networks and self-optimization deals with energy saving, load balancing, inter-cell interference coordination, coverage, capacity, etc issues. The main target of self-organization is to make communications networks more flexible. Flexibility brings a need for new ways to control communications networks.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: obtain information on load experienced by a node, overlaying cell of the node and/or neighbouring cell of the node; increase transmission power for the node being able to provide services to more users in case the overlaying cell and/or the neighbouring cell are overloaded; and otherwise decrease transmission power for reducing interference caused by the node in case the load experienced by the node allows it.

According to another aspect of the present invention, there is provided a method comprising: obtaining information on load experienced by a node, overlaying cell of the node and/or neighbouring cell of the node; if the overlaying cell and/or the neighbouring cell are overloaded, increasing transmission power for the node being able to provide services to more users; and otherwise, if the load experienced by the node allows, decreasing transmission power for reducing interference caused by the node.

According to yet another aspect of the present invention, there is provided an apparatus comprising: means for obtaining information on load experienced by a node, overlaying cell of the node and/or neighbouring cell of the node; means for increasing transmission power for the node being able to provide services to more users, in the case the overlaying cell and/or the neighbouring cell are overloaded; and means for decreasing transmission power for reducing interference caused by the node, otherwise in the case the load experienced by the node allows.

According to yet another aspect of the present invention, there is provided a computer program product embodied on a computer readable medium, the computer program being configured to control a processor to perform: obtaining information on load experienced by a node, overlaying cell of the node and/or neighbouring cell of the node; if the overlaying cell and/or the neighbouring cell are overloaded, increasing transmission power for the node being able to provide services to more users; and otherwise, if the load experienced by the node allows, decreasing trans-mission power for reducing interference caused by the node.

According to yet another aspect of the present invention, there is provided a computer-readable medium encoded with instructions that, when executed by a computer, perform: obtaining information on load experienced by a node, overlaying cell of the node and/or neighbouring cell of the node; if the overlaying cell and/or the neighbouring cell are overloaded, increasing transmission power for the node being able to provide services to more users; and otherwise, if the load experienced by the node allows, decreasing transmission power for reducing interference caused by the node.

### LIST OF DRAWINGS

Embodiments of the present invention are described below, by way of example only, with reference to the accompanying drawings, in which

FIG. 1 illustrates an example of a system;

FIG. 2 is a flow chart;

FIG. 3 illustrates examples of an apparatus.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

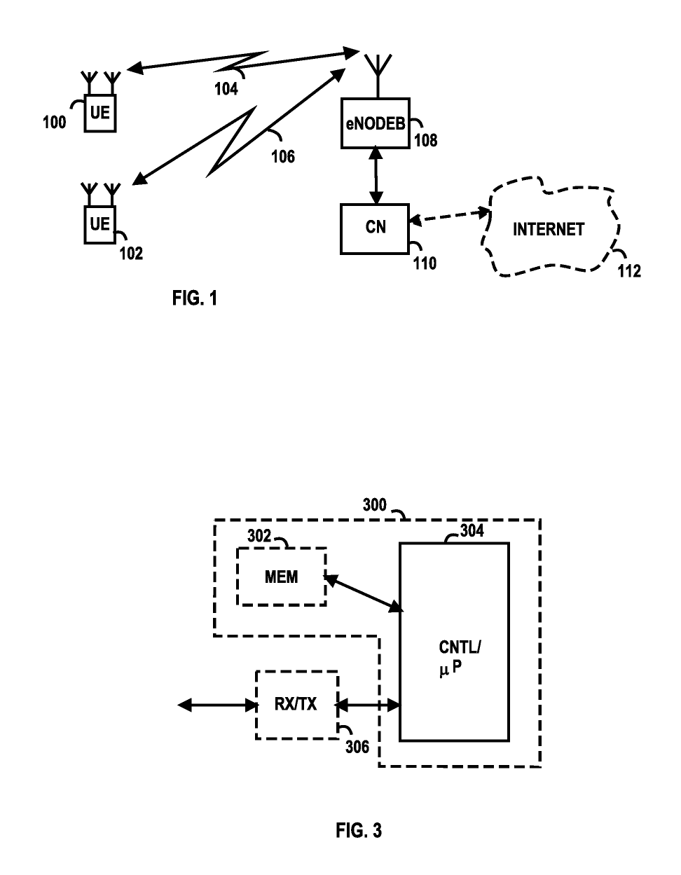

FIG. 1 is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with the necessary properties.

FIG. 1 shows a part of a radio access network of E-UTRA, LTE or LTE-Advanced (LTE-A). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for instance. From the transceivers of the (e)NodeB, a connection is provided to an antenna unit that establishes bidirectional radio links to the user devices. The antenna unit may comprise a plurality of antennas or antenna elements. The (e)NodeB is further connected to a core network 110 (CN). Depending on the system, the counterpart on the CN side can be a serving system architecture evolution (SAE) gateway (routing and forwarding user data packets), packet data network gateway (PDN GW), for providing connectivity to user devices (UEs) to external packet data networks, or mobile management entity (MME), etc.

A communications system typically comprises more than one (e)NodeB in which case the (e)NodeBs may also be configured to communicate with one another over links, typically radio links, designed for the purpose. These links may be used for signalling purposes.

The communication system is also able to communicate with other networks, such as a public switched telephone network or the Internet 112.

The user device (also called UE, user equipment, user terminal, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, laptop computer, game console, notebook, and multimedia device.

The user device (or a layer 3 relay node) is configured to perform one or more of user equipment functionalities described below with an embodiment, and it may be configured to perform functionalities from different embodiments. The user device may also be called a subscriber unit, mobile station, remote terminal, access terminal, user terminal or user equipment (UE) just to mention but a few names or apparatuses.

It should be understood that, in the FIG. 1, user devices are depicted to include 2 antennas only for the sake of clarity. The number of reception and/or trans-mission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements. At least one of the NodeBs or eNodeBs may be a Home(e)nodeB. The concept of Home(e)nodeB is explained in further detail below.

Typically, in a geographical area of a radio communication system there is provided a plurality of different kinds of radio cells as well as a plurality of radio cells as also shown in FIG. 1. Radio cells may be macro cells (or umbrella cells) which are large cells, usually having a diameter of up to tens of kilometres, or smaller cells such as micro-femto or picocells. A cellular radio system may be implemented as a multilayer network including several kinds of cells, such as macro-, micro- and picocells. The (e)NodeB 108 of FIG. 1 may provide any kind of these cells. Typically, in multilayer networks, one node B provides one kind of a cell or cells, and thus a plurality of node Bs are required to provide such a network structure. Recently for fulfilling the need for improving the deployment and performance of communication systems, concept of “plug-and-play” node (e)Bs has been introduced. Typically, a network which is able to use “plug-and-play” node (e)Bs, includes, in addition to Home node (e)Bs (Home(e)NodeBs), a home node B gateway, or HNB-GW. A HNB Gateway (HNB-GW), which is typically installed within an operator's network aggregates traffic from a large number of HNBs back to a core network through Iu-cs and Iu-ps interfaces.

Term “plug-and-play” is used herein to describe an apparatus which can be coupled to a network with a minimum configuration work, typically such an apparatus is a self-configuring device. For enabling “plug-and-play” devices a self-organizing network (SON) and flexible spectrum use (FSU) concepts have been launched. The SON concept is for instance known in connection to computer networks and neural networks. The FSU enables devices to use spectrum in a flexible manner. In future networks, more frequency bands will be needed for new high-bit-rate wireless services. A home (e)NodeB (sometimes being comparable to a femto or pico node) when coupled to broadband services providing an umbrella cell may provide radio coverage for user devices. H(e)NBs may provide the capabilities of a standard node B or a base station as well as the radio resource management functions of a standard radio network controller (RNC).

A H(e)NB when serving as a “plug-and-play” node B may be a wireless access point purchased, installed and operated by a private user, a single user or a community, such as a university or a shopping centre. Thus, the exact location of a H(e)NB under the umbrella cell (or macro cell) when the H(e)NB is wirelessly coupled to a network may not be known or it is of uncoordinated random nature which causes problems in network configuration.

A home NodeB may be used in a local area network (LAN) which is a computer network covering a relatively small geographical area, such as a home or office. Similar kinds of networks are personal area networks (PANs), campus area networks (CANs), or metropolitan area networks (MANS). Another network system where H(e)NBs are typically used is a Wide Area Network (WAN) which is a network covering a relatively broad area. A WAN may be defined to be a network whose coverage crosses metropolitan, regional, or national boundaries. Probably the best-known example is the Internet.

An example of a network system is also a mixed Local Area/Wide Area (LA/WA) scenario in which several cellular networks of the same radio access technology (e.g. E-UTRA) being operated by different operators are deployed in the same geographical area, such as a modern home-and-office building complex, and are using the same radio spectrum resources.

The mixed LA/WA scenarios may for instance refer to hierarchical cell structures, such as to a LTE/LTE or LTE/LTE-A co-existence or hot spots with overlay network. Within LA/WA coverage, H(e)NBs or local node Bs (LNBs) of the same or different networks may be placed and set up next to each other in a short distance in a spatially uncoordinated fashion.

Typically, self-organizing systems utilise intelligent radio concept. In such systems, a network and/or wireless node alters its transmission and/or reception parameters for achieving efficient communication and minimizing interference with licensed and/or unlicensed users. This alteration of parameters is usually based on monitoring external and/or internal radio environment, such as radio frequency spectrum, user behaviour and the status of the network.

In the following, an embodiment of a method for downlink power control is explained in further detail.

Due to the need for increased amount of traffic in communications networks, a multi-layer radio access network (RAN) deployment becomes more and more critical. A typical multi-layer network comprises a macro-cell, also called an “umbrella” cell, and one or more smaller cells under this “umbrella”. The lower-layer cells may be micro, femto or pico cells. The network may simultaneously be not only a multi-layer system, but also a multi-vendor system. The system may also support “plug-and-play” functionality in which case low power nodes with open access may be deployed under already available “umbrella” coverage in order to locally enhance network capacity. Introduction of such a node improves locally experienced user device (UE) throughput but at the same time introduces additional interference to other cells (macro or lower power nodes) under the radio coverage.

The overall gain of a multi-layer network deployment comes from off-loading effect. Off-loading usually means transferring data away (off) from crowded networks or cells. Typically, users of a higher layer cell are served by lower layer cells whenever possible. Since the serving area of a node is dependent on its transmission power, on which, in turn, the option of transferring load is dependent, flexible power control is needed in order to reduce unnecessary interference and enabling the usage of off-loading possibility.

It should be appreciated that power control of low power nodes having close or hybrid access, such as H(e)NBs, as a function of reference signal received power (RSRP) of a strongest macro node that is used in LTE systems, when applied to an outdoor open access case, would result in serving area reduction for low power nodes, especially in close proximity to the macro node. This procedure would therefore decrease the probability of traffic off-load from the macro node to the lower power nodes and thus diminish the gain obtainable from the multi-layer structure.

In one embodiment, transmission power of a micro, femto and/or pico node (or another node of corresponding size and/or functional purpose) is adjusted taking into account load experienced by the micro, femto or pico node under discussion, load experienced by a higher layer node (one or more) of the micro, femto or pico node and the transmission power headroom of the micro, femto or pico node.

An embodiment starts in block 200. The embodiment is especially suitable for multi-layer systems having one or more “umbrella” cells as higher layer cells and at least one lower layer cell, typically a micro, femto or pico cell. It should be understood that multi-layer systems may comprise more layers than these two and only a simplified example is described herein with a view to clarify embodiments.

In block 202, information on load experienced by a node, overlaying cell of the node and/or neighbouring cell of the node is obtained.

A node herein is in a usual case a micro, pico or femto node describing a lower power node serving under an umbrella cell. Information on the load experienced by a node may be obtained by measurements the node carries out.

Information on the load experienced by the node is obtainable by monitoring; the node is typically aware of its own load situation.

Information on the load experienced by an overlaying cell (“umbrella” cell) of the node may be obtained by retrieving it for example from cell access restriction (IE) information which may be broadcasted when an operator is restricting access to a cell. The information may also be received in some other message. The overlaying cell may be a macro cell.

Information on load experienced by one or more neighbouring cells of the node may be obtained by retrieving it from the neighbour cells. It may for example be carried out by receiving messages carrying load information from the neighbouring nodes or from the overlaying node. The neighbours that are most significant for the node under discussion are typically the strongest ones, or the ones having overlapping area with the node under discussion.

Implementation in LTE systems may be based on normally available information. Information on an overlay node is obtainable in X2 interface between the overlay node and a lower level node in IE LOAD INFORMATION (see TS 36.423 8.3.1.2).

In block 204: if the overlaying cell and/or the neighbouring cell are overloaded, transmission power is increased for the node being able to provide services to more users. Typical criterion for the overload is to carry out a comparison to a set first threshold that is to say studying whether the load exceeds and/or achieves a predetermined threshold. The threshold may be set statically upon network configuration carried out by operation and maintenance functions, or it may be slowly adjusted based on SON mechanism. A combination of these both alternatives is also an option especially in LTE systems.

The transmission power increase may also be controlled by using an upper limit which is based on available power headroom and free resources. The power headroom is typically defined as the maximum power available for user device transmission excluding transmission power currently used by the user device. The power headroom is usually defined individually for each user device.

The power increase is not possible, however, if the node is already overloaded, for instance with guaranteed bit rate (GBR) traffic. Thus the node may monitor the node load by using a second threshold set for load. The second threshold for load may also be set statically upon network configuration carried out by operation and maintenance functions or it may be slowly adjusted based on SON mechanism. A combination of these both alternatives is also an option especially in LTE systems.

It should also be understood that usually a maximum allow-able transmission power is determined for each node. Thus transmission power cannot be increased above this limit without permission that typically requires at least partly renewing the network configuration.

In block 206: otherwise, if the load experienced by the node allows, transmission power is decreased for reducing interference caused by the node.

The suitable power reduction scheme may be evaluated according to the following principles: no change is caused to the number of served user devices (information on the load experienced by the node is obtained mostly for preventing connection drops in case the node is considering decreasing of its transmission power), experienced load does not rise higher than thresholds set for the load in the node under discussion, and transmission power does not get lower than that determined by minimum requirement set for the transmission power.

The power adjustment level may be determined based on experienced signal-to-noise and interference-ratio (SINR) in relation to transmission power and/or load. The power adjustment level may be estimated by simulations or derived dynamically based on the parameters listed above for power reduction scheme. The power adjustment may also be carried out stepwise in which case the adjustment step size may be set by operation and maintenance functions in the similar manner than a traditional power adjustment step.

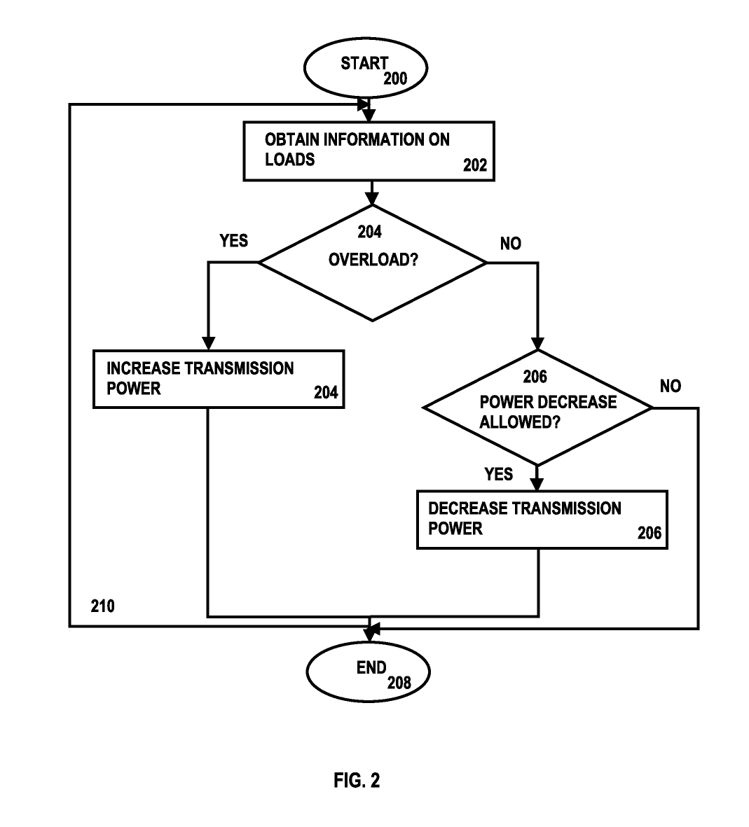

The embodiment ends in block 208. The embodiment is repeatable in many ways. One example is shown by arrow 210 in FIG. 2.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that transmitting and/or receiving may herein mean preparing a transmission and/or reception, preparing a message to be transmitted and/or received, or physical transmission and/or reception itself, etc on a case by case basis.

In the following, an example of a communication system, wherein the embodiment of FIG. 2 may be applied to, is explained in more detail. The system is based on the part of a communication system described in FIG. 1. An example of a network wherein embodiments can be applied to is heterogeneous networks with one or more macro cells and H(e)NodeB cells which may be targeted to a restricted group of users. One example of such a H(e)NodeB cell which restricted access is a closed subscriber group (CSG) cell. The system is served by an “umbrella” cell (macro cell) provided by an (e)NodeB which is not shown in the FIG. 1. In the system, a plurality of different kinds of nodes are provided, at least part of them being H(e)NodeBs (or “plug-and-play” (e)NodeBs). Each H(e)NodeBs may provide a lower level node. H(e)NodeB may be a any node, server or host provided by necessary functionalities, it may even be a developed user device, such as a laptop, multimedia device or some other computer device furnished with a network stick or a corresponding device. A developed network stick may also provide all the necessary functionalities. In the example of FIG. 1, (e)NodeB is a H(e)NodeB providing a femto or pico cell.

Embodiments may also be applied to other networks, as already stated above. As an example of such networks are herein taken High Speed Packet Access (HSPA) networks. High Speed Packet Access is designed to be able to provide high data rate transmission to support multimedia services. HSPA allows networks based on Universal Mobile Telecommunications System (UMTS) to have higher data transfer rates and capacity. HSPA includes High Speed Downlink Packet Access (HSDPA) and/or High Speed Uplink Packet Access (HSUPA). HSUPA uses a packet scheduler and it operates on a request-grant principle that is a user device requests a permission to send data and the packet scheduler decides on resource allocation. Further rate increases are available with evolved HSPA, also called HSPA+. Additionally, evolved HSPA introduces optional all-Internet Protocol (IP) architecture in the case node Bs or base stations are directly coupled to an IP based backhaul.

An embodiment provides an apparatus which may be any node, host, user device, network stick or any other suitable apparatus able to carry out processes described above in relation to FIG. 2.

FIG. 3 illustrates a simplified block diagram of an apparatus according to an embodiment. It should be appreciated that the apparatus may also include other units or parts than those depicted in FIG. 3. Although the apparatus has been depicted as one entity, different modules and memory may be implemented in one or more physical or logical entities.

The apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

As an example of an apparatus according to an embodiment, it is shown an apparatus, such as a node device, including facilities in a control unit 300 (including one or more processors, for example) to carry out functions of embodiments, such as negotiations between node devices for obtaining resources. This is depicted in FIG. 3.

Another example of an apparatus may include at least one processor 304 and at least one memory 302 including a computer program code, the at least one memory and the computer program code configured to, with the at least one processor, cause the apparatus at least to: obtain information on load experienced by a node, overlaying cell of the node and/or neighbouring cell of the node, increase transmission power for the node being able to provide services to more users in case the overlaying cell and/or the neighbouring cell are overloaded, and otherwise decrease transmission power for reducing interference caused by the node in case the load experienced by the node allows it. Yet another example of an apparatus comprises means 304 for obtaining information on load experienced by a node, overlaying cell of the node and/or neighbouring cell of the node, means 304 for increasing transmission power for the node being able to provide services to more users, and means 304 for otherwise decreasing transmission power for reducing interference caused by the node in case the load experienced by the node allows it.

Yet another example of an apparatus comprises an obtainer 304 configured to obtain information on load experienced by a node, overlaying cell of the node and/or neighbouring cell of the node, an increaser 304 configured to increase transmission power for the node being able to provide services to more users in case the overlaying cell and/or the neighbouring cell are overloaded, and an decreaser 304 configured to decrease transmission power for reducing interference caused by the node in case the load experienced by the node allows it. The obtainer, increaser and decreaser are depicted in FIG. 3 as included in a control unit or microprocessor 304.

It should be appreciated that different units may be implemented as one module, unit, processor, etc, or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control, etc depending on the implementation. Receiving may herein mean receiving via antennas from a radio path, carrying out preparations for physical receptions or reception control, etc depending on the implementation. The apparatus may utilize a transmitter and/or receiver which are not included in the apparatus itself, such as a processor, but are available to it, being operably coupled to the apparatus. This is depicted in FIG. 3 as transceiver 306.

An embodiment provides a computer program embodied on a distribution medium, comprising program instructions which, when loaded into an electronic apparatus, constitute the apparatus as explained above.

Another embodiment provides a computer program embodied on a computer readable medium, configured to control a processor to perform embodiments of the method described above.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
obtain information on load experienced by a node, overlaying cell of the node and/or neighbouring cell of the node;
increase transmission power for the node being able to provide services to more users in case the overlaying cell and/or the neighbouring cell are overloaded; and
otherwise decrease transmission power for reducing interference caused by the node in case the load experienced by the node allows it.

2. The apparatus of claim 1, wherein the node is a micro, pico or femto node and the overlaying cell is a macro cell.

3. The apparatus of claim 1, wherein the information on the load experienced by the overlaying cell of the node is obtained from cell access restriction (IE) information.

4. The apparatus of claim 1, wherein most significant neighbours for the node are the strongest ones, or the ones having overlapping area with the node.

5. The apparatus of claim 1, further configured to:
use as a criterion for the overload a comparison to a predetermined first threshold which first threshold is set by using at least one of: upon network configuration based on available statistical information and slowly adjusted based on self-organizing networks mechanism.

6. The apparatus of claim 1, further configured to:
control the transmission power increase by using an upper limit which is based on available power headroom and free resources.

7. The apparatus of claim 1, further configured to:
monitor the node load by using a predetermined second threshold which second threshold is set by using at least one of: upon network configuration based on available statistical information and slowly adjusted based on self-organizing networks mechanism.

8. The apparatus of claim 1, the apparatus comprising a node.

9. (canceled)

10. A method comprising:
obtaining information on load experienced by a node, overlaying cell of the node and/or neighbouring cell of the node;
if the overlaying cell and/or the neighbouring cell are overloaded, increasing transmission power for the node being able to provide services to more users; and
otherwise, if the load experienced by the node allows,
decreasing transmission power for reducing interference caused by the node.

11. The method of claim 10, wherein the node is a micro, pico or femto node and the overlaying cell is a macro cell.

12. The method of claim 10, further comprising obtaining the information on the load experienced by the overlaying cell of the node from cell access restriction (IE) information.

13. The method of claim 10, wherein most significant neighbours for the node are the strongest ones, or the ones having overlapping area with the node.

14. The method of claim 10, further comprising:
using as a criterion for the overload a comparison to a predetermined first threshold which first threshold is set by using at least one of: upon network configuration based on available statistical information and slowly adjusted based on self-organizing networks mechanism.

15. The method of claim 10, further comprising:
controlling the transmission power increase by using an upper limit which is based on available power headroom and free resources.

16. The method of claim 10, further comprising:
monitoring the node load by using a predetermined second threshold which second threshold is set by using at least one of: upon network configuration based on available statistical information and slowly adjusted based on self-organizing networks mechanism.

17. An apparatus comprising:
means for obtaining information on load experienced by a node, overlaying cell of the node and/or neighbouring cell of the node;
means for increasing transmission power for the node being able to
provide services to more users, in the case the overlaying cell and/or the neighbouring cell are overloaded; and
means for decreasing transmission power for reducing interference caused by the node, otherwise in the case the load experienced by the node allows.

18. A computer program product embodied on a computer readable medium, the computer program being configured to control a processor to perform:
obtaining information on load experienced by a node, overlaying cell of the node and/or neighbouring cell of the node;
if the overlaying cell and/or the neighbouring cell are overloaded,
increasing transmission power for the node being able to provide services to more users; and
otherwise, if the load experienced by the node allows,
decreasing transmission power for reducing interference caused by the node.

19. The computer program product of claim 18, wherein the node is a micro, pico or femto node and the overlaying cell is a macro cell.

20. The computer program product of claim 18, further configured to control a processor to perform:
using as a criterion for the overload a comparison to a predetermined first threshold which first threshold is set by using at least one of: upon network configuration based on available statistical information and slowly adjusted based on self-organizing networks mechanism.

21. The computer program product of claim 18, further configured to control a processor to perform:
controlling the transmission power increase by using an upper limit which is based on available power headroom and free resources.

22. The computer program product of claim 18, further configured to control a processor to perform:
monitoring the node load by using a predetermined second threshold which second threshold is set by using at least one of: upon network configuration based on available statistical information and slowly adjusted based on self-organizing networks mechanism.

23. (canceled)

24. (canceled)
